(19) United States
(12) Patent Application Publication
(10) Pub. No.: US 2007/0268513 A1
(43) Pub. Date: Nov. 22, 2007

(54) Method and system for print production conflict visualization

(75) Inventor: Timothy M. Enloe, Pleasant Hill, CA (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/437,032

(22) Filed: May 19, 2006

(51) Int. Cl. G06F 3/12

(52) U.S. Cl. 358/1.15

(57) ABSTRACT

A method for document print production conflict visualization and resolution selects a document and a job ticket for printing, with the job ticket including various document publishing requirements. Conflict analysis is performed to identify at least one conflict among the document publishing requirements and a visualization of each identified conflict is sequentially presented on a user interface. The visualizations utilize graphical clues, superimposed upon the rendering of a 3D model of the document, to clearly illustrate the nature of each problem, and sequentially show how each available suggested solution would resolve the conflict. The user interface requests approval to proceed with problem resolution if a conflict is identified among the publishing requirements or indicates that no conflict is present.

### BACKGROUND AND SUMMARY

This disclosure relates generally to methods and systems for document print production visualization, and more particularly to a system and method for the viewing of images of document print production conflicts so as to provide a capability for proofing the document and resolving the conflicts before production.

To accommodate economic demands, the printing industry is adopting such practices as Lean Manufacturing and Computer Integrated Manufacturing (CIM) from order entry to delivery and invoice. The Job Description Format (JDF) and Job Management Format (JMF) are two technical standards being proposed to help ease the flow of data, information, and content within and among the printing industry. The JDF/JMF standards are perceived as enablers for the printing industry to move to a CIM type of production process, thereby reducing production costs and improving efficiency.

A goal of the disclosed system and method is to transform the current production print practice by providing an easy to use document production visualization system that permits visualization of possible conflicts resulting from the print specifications of individual job tickets. The JDF language provides a means for specifying a complex set of publishing and binding options for documents that are to be produced by a printing business. Some currently existing software tools, such as Adobe Acrobat Pro 7.0 and CIP4's JDF Editor, will verify the syntax of a job ticket (JDF Instance) and provide a simple collection of icons that represent the structure and components of JDF that has been loaded into such software applications. However, as with many software ‘languages’, it is possible to be syntactically correct but logically incorrect. In the case of JDF, it is possible to describe many combinations of publishing options that are physically impossible or very undesirable, and the syntax checkers will not notice, much less provide options or advice for resolving the problems. Consequently, a customer has no assurance that the print shop that has been chosen is capable of producing the document as intended, unless every print job is reviewed by a well trained expert who is very familiar with all the capabilities of a given print shop.

All U.S. patents and published U.S. patent applications cited herein are fully incorporated by reference. The following patents or publications are noted:

U.S. patent application Ser. No. 11/001,431 Rolleston (“System and Method for Document. Production Visualization”) describes a pre-print visualization method that includes submitting the content of the printing job, and associated printing environment data, in order to create a virtual rendering of the job in 3D on a user interface. The rendering may be a low-resolution rendering or alternatively, the rendering would employ print-quality representations of content. The virtual rendering also allows a user to observe job-specific aspects and change a point of view relative to the rendering, including selecting and viewing individual pages of the print job.

U.S. Pat. Nos. 6,134,568 and 6,616,702 to Tonkin (“Previewing an Assembled Document”) describe a user interface that enables a user to input information specifying an arrangement of components to create the document, with the components including a printed page, a tab page, a blank page, a front cover, a back cover, and a binding. Digital images of some of the components specified by the input information are obtained and an image of the document is generated by combining the digital images of some of the components to simulate an appearance of the document. The user is also able to preview a document via the user interface provided, which enables a user to specify a source file containing content for the document, specify an arrangement of components to create the document, and define the pages to be printed. An image of the document is then generated and displayed by combining digital images of some of the components to simulate the appearance of the assembled document.

The disclosed embodiments provide examples of improved solutions to the problems noted in the above Background discussion and the art cited therein. There is shown in these examples an improved method for document print production conflict visualization and resolution. The method selects a document and a job ticket for printing, with the job ticket including various document publishing requirements. Conflict analysis is performed to identify at least one conflict among the document publishing requirements, and for each conflict found a visualization of the conflict is presented on a user interface. The visualization utilizes graphical clues superimposed upon the rendering of a 3D model of said document. The user interface requests approval to proceed with problem resolution if a conflict is identified among the publishing requirements or indicates that no conflict is present.

In an alternate embodiment there is disclosed a system for document print production conflict visualization and resolution. The system provides means for selecting a document and a job ticket for printing. Conflict analysis is utilized to identify conflicts among the document publishing requirements provided by the job ticket. A user interface indicates whether any conflicts are present and utilizes graphical clues superimposed upon the rendering of a 3D model of the document to visualize each conflict. The interface also requests approval to proceed with problem resolution if a conflict(s) is identified among the document publishing requirements.

In yet another embodiment there is disclosed a computer-readable storage medium having computer readable program code embodied in the medium which, when the program code is executed by a computer, causes the computer to perform method steps for document print production conflict visualization and resolution. The method includes selecting a document and a job ticket for printing, with the job ticket including various document publishing requirements. Conflict analysis is performed to identify conflicts among the document publishing requirements and a visualization of each conflict is presented sequentially on a user interface. The visualization utilizes graphical clues superimposed upon the rendering of a 3D model of said document. The user interface requests approval to proceed with problem resolution if a conflict is identified among the publishing requirements or indicates that no conflict is present.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is an illustration of one example of a print production network which could utilize the production conflict visualization system and method;

FIG. 2 is an overview of the architecture of the production conflict visualization system;

FIG. 3 is a flow chart illustrating operation of the method for production conflict visualization;

FIG. 4 is an illustration of one example of a production conflict visualized on the production conflict resolution interface;

FIG. 5 is another illustration of one example of a production conflict visualized on the production conflict resolution interface; and

FIG. 6 is yet another illustration of one example of a production conflict visualized on the production conflict resolution interface.

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The production conflict visualization interface and method improves upon the existing methods of illustrating physical or logical problems that may exist with a JDF Instance. A detailed 3D model of the document being published and the results of a JDF conflict analysis draw a user's attention to parts of the model that have been determined to have conflicts with the document production process to be used. The interface sequentially brings each potential problem to the user's attention using intuitive graphical clues superimposed upon the rendering of the 3D model and provides textual information as needed to make the problem clear to the user. The interface then provides the user with a list of potential solutions, allows the user to select one, and immediately updates the JDF Instance (job ticket) and the 3D model to reflect the alternative document production options selected by the user, thus allowing the user to view the results of each decision as it is made. While for the purposes of discussion the interface is described as operating with the JDF language, the method and system could be used in conjunction with any other formatted language utilized by document printing systems to describe print job production parameters.

Various computing environments may incorporate capabilities for supporting a network on which the production conflict visualization method and system may reside. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

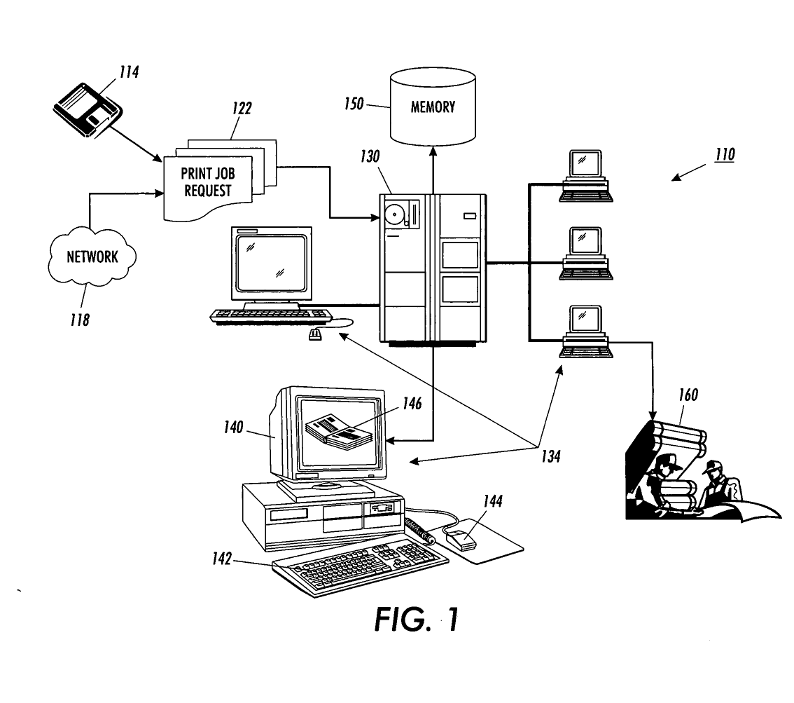

Referring to FIG. 1, there is depicted an exemplary system 110 on which the production conflict visualization method and features may be implemented. It is to be understood that certain aspects of the system would operate in accordance with pre-programmed instructions used to operate a local or networked computer system to carry out such features—perhaps on a plurality of interconnected computers at a time. Such a system might include a commercially available personal computer with appropriate graphics rendering capability that can also be associated with a networked storage medium or similar memory device wherein the system is accessible, perhaps via an Internet or intranet for submission of print jobs. It is also contemplated that one or more aspects of the system may be implemented on a dedicated computer workstation.

The content for a printing job is initially provided by the customer in a form acceptable to the system. Although depicted as a disk 114 or an Internet connection 118, it will be appreciated that various media and communication techniques may be available for a customer to supply the necessary content in a digital form. The content and specification for the customer's job would, however, need to be converted to a standard format such as JDF, which uses an extensible markup language (XML) to define the content of, and processes for, the creation of the printed document(s).

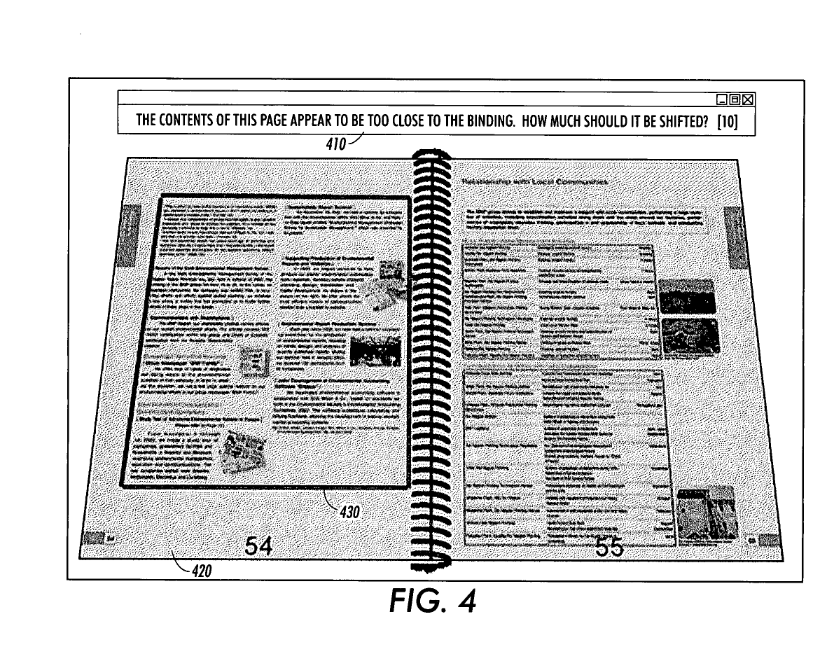

Networked DPV (Document Production Visualization) processor 130 operates in accordance with suitable pre-programmed software to store the JDF data in a memory 150 and to carry out the conversion of the JDF data to suitable objects for virtual rendering on a workstation 134. Workstation 134 provides the user interface in the form of a display 140, a keyboard 142 and a mouse 144 or similar pointing device. As illustrated in FIGS. 4-6, workstation 134 provides a display suitable for providing a virtual rendering of the document (book) and existing conflicts in the job ticket specification for review by the user. Once the author/publisher of the document has approved a final version of the job ticket (as shown in virtual rendering 146) for production, the approved JDF and associated virtual rendering data is again stored or updated on memory 150. The job ticket is then sent to printer 160 for production.

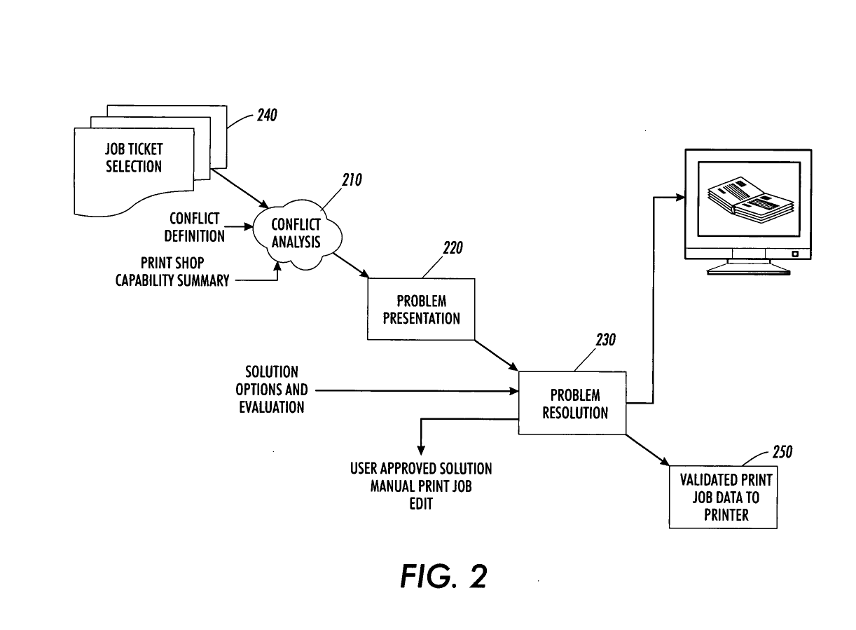

Turning now to FIG. 2, a generalized illustration of the technology architecture involved in the production conflict visualization system is illustrated. The method and system for production conflict visualization are intended to utilize virtual rendering, exposed through a GUI, to alert the user that conflicts exist within the job ticket providing instructions for specific print production jobs and to present various options for resolving the conflicts to meet customer requirements, presented visually on a user interface. The job ticket is then updated with the selected solutions and becomes the intent specification for production.

After a user selects a specific job ticket at 240, a detailed 3D model of the document that would result from processing the instructions in the JDF file (the job ticket), is constructed in a format that can be rendered by a modern OpenGL compatible graphics circuitry. Conflict analysis module 210 uses a conflict definition list and a printshop capability summary to determine if there are any conflicts in the JDF file that need to be brought to the users attention. The results of this logical analysis of the JDF file are used by the system to draw the user's attention to parts of the model that have been determined to have the potential to cause problems in the document production process, or are likely to yield undesirable final results. Examples of such problems include, but are not limited to, placement of the page contents too close to the binding, use of a non-recommended procedure, such as stapling of transparencies, incompatibility of the number of pages in the document with the binding type requested, a binding not sized properly in length for the chosen media chosen, media holes incompatible with the binding, differing hole patterns in the various media sheets, page contents too large to fit on chosen media, print shop equipment unable to support the chosen binding, media size, media type, covers, plexing, color printing, etc., or the chosen print shop may not stock a given binding, media, etc.

Each of these potential problems is brought to the user's attention with problem presentation module 220, which uses intuitive graphical clues superimposed upon the rendering of the 3D model, and provides textual information, in layman's terms, that details for the user why the object “highlighted”, or otherwise indicated, at that moment needs to be reviewed and resolved in some fashion. These graphical clues may take the form of “flashing” the object that needs attention (for example, the binding), prominent flashing arrows that point at an object, or red/flashing boxes may be drawn around the problem area or object. Alternatively, the clues may take the form, but are not limited to, all components except save the problematic one may be made transparent/invisible, a figurine of a person/character could point at the problem, jump up and down on the problem, etc., or measurements/rulers can be superimposed upon the visualization. The problem resolution module 230 then provides the user a list of potential solutions for each problem and allows the user to select one (or indicate an alternative), and update the JDF and the 3D model to reflect the user's feedback. The validated job ticket is then sent to the printer at 250 for production.

As will be described in more detail below, the graphical representation of the conflicts present in a job ticket specification is a critical aspect in creating a user interface for the production conflict visualization system. The interface must be interactive so that the user is able to explore various solutions for the production conflicts.

The particular methods performed by the system for visualization of job ticket conflicts comprise steps which are described below with reference to a series of flow charts. The flow charts illustrate an embodiment in which the methods constitute computer programs made up of computer-executable instructions. Describing the methods by reference to a flowchart enables one skilled in the art to develop software programs including such instructions to carry out the methods on computing systems. The language used to write such programs can be procedural, such as Fortran, or object based, such as C++. One skilled in the art will realize that variations or combinations of these steps can be made without departing from the scope of the disclosure herein.

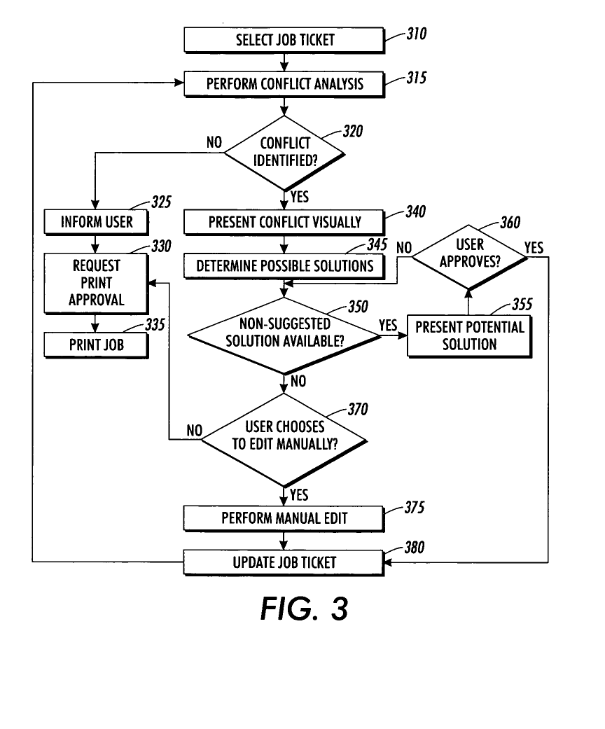

Turning to FIG. 3, there is shown a flow chart illustrating one embodiment of the method for production conflict visualization. Job ticket selection is performed at 310, with the user being prompted to select a document for printing and a JDF Instance to edit. Conflict analysis is performed at 315 to identify any problems that could arise in the document production process. The conflict analyzer utilizes a list of conflict definitions, a print shop capability summary, the requirements as presented in the selected job ticket, updates to the job ticket, and annotations on problems that the user has chosen to ignore. If a conflict is not identified at 320, the user is informed that no problems were found at 325. The user interface then requests the user's approval to print the document in its current state at 330. If this approval is obtained, the validated job ticket and print job data are transmitted to the printer input queue and the print job is processed through the printer at 335. In those instances in which the user elects not to print the job, the interface is exited or a new job ticket is selected.

If a conflict is identified at 320, the interface provides a visual clue to the user to highlight the problem at 340 and requests the user's approval to begin the problem solving process. Upon receipt of the user's authorization, at 345 possible solutions are identified and at 350 a determination is made as to whether a solution(s) are available that have not yet been suggested to the user. For any solution not yet suggested to the user, a visual clue is provided to the user at 355 to illustrate the potential solution. If the user approves the suggested solution at 360, the job ticket is updated at 380 and another conflict analysis is performed at 315 until all problems with the job ticket are resolved. In those cases in which the user does not approve the suggested solution, another determination is made at 350 to identify existing solution(s) that have not already been suggested. Alternate suggestions are presented for approval until the user selects a solution at 360 or no alternate suggestions exist. If no alternate solutions exist, the interface requests the user's approval to enter the manual override edit mode.

Upon selection of the manual override edit mode at 370, the user performs a manual edit on the visualization on the interface at 375, the job ticket is updated at 380, and another conflict analysis is performed until no further problems exist within the selected job ticket. If the user elects not to enter the user override edit mode at 370, the interface then requests the user's approval to print the document in its current state at 330. If this approval is obtained, the validated job ticket and print job data are transmitted to the printer input queue and the print job is processed through the printer at 335. In those instances in which the user elects not to print the job, the interface is exited or a new job ticket is selected.

Examples of visual clues illustrating problems and suggesting possible solutions are provided in FIGS. 4-6. Referring to FIG. 4, one problem example is printed objects on a page that are too close to the binding and so are in danger of being obscured or clipped by the binding process. The visualization provides a view of the open book 420 to the page with the problem. The text or material that is the problem is highlighted, in this illustration with a box 430 around the material that may need to be shifted, although any known method for highlighting the problem may be utilized. A dialog box 410 that describes the problem and suggests a possible solution is opened. A suggested value for shifting may be presented, but the user is also permitted to override the suggestion with a value of the user's choosing. For the purposes of discussion, in this example embodiment ‘10’ is used as the units with which the user has chosen to work when setting preferences for the editor. When the change has been approved, the JDF and the 3D model being displayed are updated to reflect the change in the placement of the page contents.

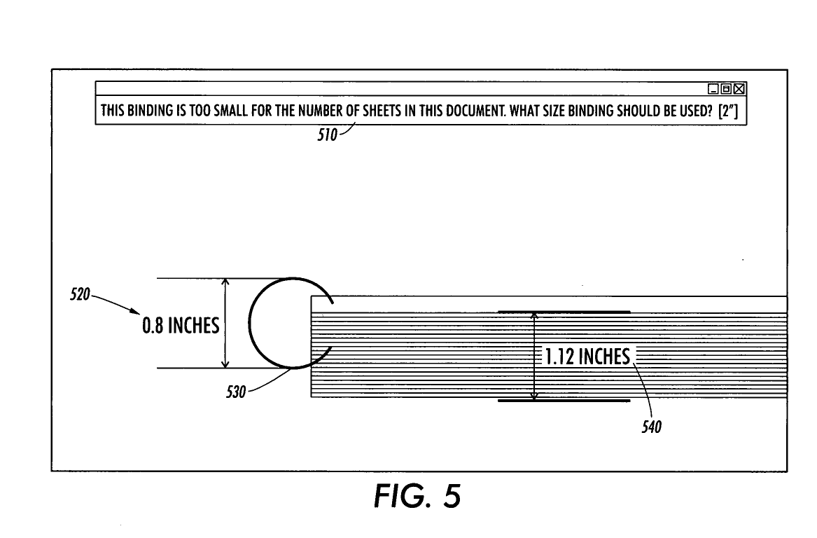

Turning now to FIG. 5, another possible problem is a binding sized too small for the number of sheets in the document. In this case the visual clue shows the binding type 530 with its binding capability 520. The calculated thickness for the number of sheets in the document is calculated and presented at 540. Dialog box 510 describes the problem and suggests a binding size, in this example two inches. If the user selects the suggested binding size, the job ticket and visualization are updated to reflect the selected solution. Otherwise, a determination is made whether an alternate solution that has not yet been suggested exists and this is presented through the user interface. This process continues until a solution is selected, manual override is selected, the user elects to print the job in its current state, or the job ticket is canceled.

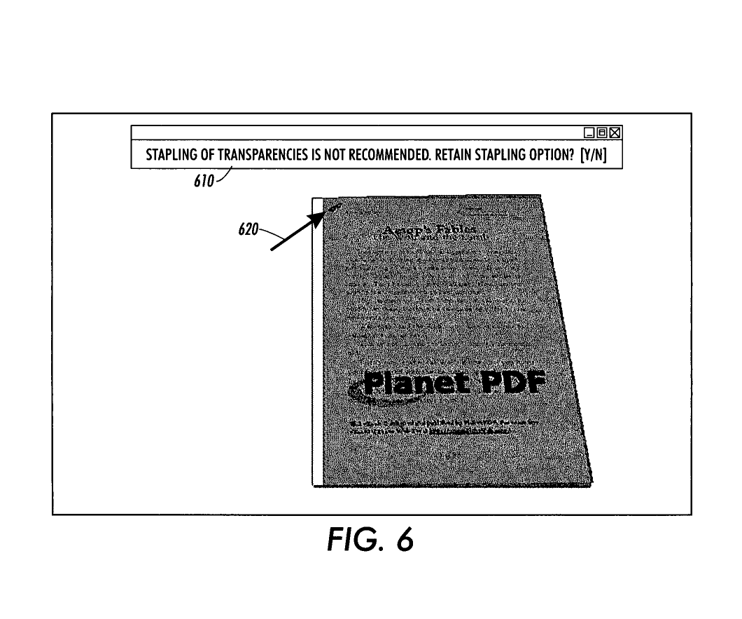

Referring to FIG. 6, yet another possible problem is illustrated. In this example, a selected job ticket has specified stapling of transparencies, highlighted with an arrow at 620. The dialog box 610 indicates that the procedure is not recommended and requests confirmation from the user that the stapling option is to be retained. If the user decides to retain the stapling procedure, the user may elect to print the job or cancel the job ticket.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A method for document print production conflict visualization and resolution, comprising:
selecting a document and a job ticket for printing, wherein said job ticket includes a plurality of document publishing requirements;
performing conflict analysis to identify at least one conflict among said document publishing requirements;
presenting a visualization of said at least one conflict, wherein said visualization utilizes graphical clues superimposed upon the rendering of a 3D model of said document;
indicating that no conflicts are present if no conflicts are identified among said document publishing requirements; and
requesting approval to proceed with problem resolution if at least one conflict is identified among said document publishing requirements.

2. The method for document print production conflict visualization and resolution according to claim 1, wherein said conflict analysis includes evaluating print shop capabilities and said document publishing requirements.

3. The method for document print production conflict visualization and resolution according to claim 1, wherein presenting said visualization includes indicating at least one said conflict in said visualization.

4. The method for document print production conflict visualization and resolution according to claim 3, wherein indicating at least one said conflict further includes indicating a potential solution to said conflict.

5. The method for document print production conflict visualization and resolution according to claim 1, further comprising annotating that an identified conflict is to be ignored if approval is denied for proceeding with said problem resolution.

6. The method for document print production conflict visualization and resolution according to claim 1, further comprising determining whether at least one potential solution is available for said identified conflict if approval is obtained for proceeding with said problem resolution.

7. The method for document print production conflict visualization and resolution according to claim 6, further comprising:
providing at least one visual clue to illustrate at least one said potential solution; and
requesting approval of said potential solution.

8. The method for document print production conflict visualization and resolution according to claim 7, further comprising updating said job ticket with an approved potential solution and repeat performing said conflict analysis until no conflicts remain to be resolved.

9. The method for document print production conflict visualization and resolution according to claim 7, further comprising:
determining whether at least one not yet suggested potential solution is available for said identified conflict if said potential solution is not approved;
providing at least one visual clue to illustrate at least one said not yet suggested potential solution;
requesting approval of said not yet suggested potential solution;
repeating determining whether at least one not yet suggested potential solution is available, providing said at least one visual clue, and requesting approval of said potential solution until a suggested potential solution is approved;
updating said job ticket with an approved potential solution; and
repeating performing said conflict analysis until no conflicts remain to be resolved.

10. The method for document print production conflict visualization and resolution according to claim 7, further comprising:
determining whether at least one not yet suggested potential solution is available for said identified conflict;
requesting approval to enter manual override edit mode if at least one not yet suggested solution is not available for said identified conflict;
activating manual override edit mode;
updating said job ticket with a conflict solution specified through said manual override edit mode; and
repeating performing said conflict analysis until no conflicts remain to be resolved.

11. The method for document print production conflict visualization and resolution according to claim 7, further comprising:
determining whether at least one not yet suggested potential solution is available for said identified conflict;
requesting approval to enter manual override edit mode if at least one not yet suggested solution is not available for said conflict; and
requesting approval to print said document in current state if manual override edit mode is not activated.

12. The method for document print production conflict visualization and resolution according to claim 1, wherein said visualization further includes textual information describing said conflict.

13. The method for document print production conflict visualization and resolution according to claim 1, wherein said graphical clues include at least one member selected from the group consisting of highlighting, arrows, boxes drawn around a problem area or object, flashing areas, contrasts of transparent and non-transparent components, a figurine of a person or character pointing at or circling around the problem, or measurements or rulers superimposed upon the visualization.

14. A system for document print production conflict visualization and resolution, comprising:
means for selecting a document and a job ticket for printing, wherein said job ticket includes a plurality of document publishing requirements;
means for performing conflict analysis to identify at least one conflict among said document publishing requirements;
means for presenting a visualization of at least one said conflict, wherein said visualization utilizes graphical clues superimposed upon the rendering of a 3D model of said document;
means for indicating that no conflicts are present if no conflicts are identified among said document publishing requirements; and
means for requesting approval to proceed with problem resolution if at least one conflict is identified among said document publishing requirements.

15. The system for document print production conflict visualization and resolution according to claim 1, further comprising means for determining whether at least one potential solution is available for said identified conflict if approval is obtained for proceeding with said problem resolution.

16. The system for document print production conflict visualization and resolution according to claim 15, further comprising:
means for providing at least one visual clue to illustrate at least one said potential solution; and
means for requesting approval of said potential solution.

17. The system for document print production conflict visualization and resolution according to claim 15, further comprising:
means for determining whether at least one not yet suggested potential solution is available for said identified conflict if said potential solution is not approved;
means for providing at least one visual clue to illustrate at least one said not yet suggested potential solution;
means for requesting approval of said not yet suggested potential solution;
means for repeating determining whether at least one not yet suggested potential solution is available, providing said at least one visual clue, and requesting approval of said potential solution until a suggested potential solution is approved;
means for updating said job ticket with an approved potential solution; and
means for repeating performing said conflict analysis until no conflicts remain to be resolved.

18. The system for document print production conflict visualization and resolution according to claim 15, further comprising:
means for determining whether at least one not yet suggested potential solution is available for said identified conflict;
means for requesting approval to enter manual override edit mode if at least one not yet suggested solution is not available for said identified conflict;
means for activating manual override edit mode;
means for updating said job ticket with a conflict solution specified through said manual override edit mode; and
means for repeating performing said conflict analysis until no conflicts remain to be resolved.

19. The system for document print production conflict visualization and resolution according to claim 15, further comprising:
means for determining whether at least one not yet suggested potential solution is available for said identified conflict;
means for requesting approval to enter manual override edit mode if at least one not yet suggested solution is not available for said conflict; and
means for requesting approval to print said document in current state if manual override edit mode is not activated.

20. A computer-readable storage medium having computer readable program code embodied in said medium which, when said program code is executed by a computer causes said computer to perform method steps for document print production conflict visualization and resolution, the method comprising:
selecting a document and a job ticket for printing, wherein said job ticket includes a plurality of document publishing requirements;
performing conflict analysis to identify at least one conflict among said document publishing requirements;
presenting a visualization of said at least one conflict, wherein said visualization utilizes graphical clues superimposed upon the rendering of a 3D model of said document;
indicating that no conflicts are present if no conflicts are identified among said document publishing requirements; and
requesting approval to proceed with problem resolution if at least one conflict is identified among said document publishing requirements.
